(19) United States
(12) Patent Application Publication
(10) Pub. No.: US 2004/0077188 A1
(43) Pub. Date: Apr. 22, 2004

(54) Card connector assembly including contact lands having no damage

(75) Inventor: Kenichi Tanoue, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/675,700

(22) Filed: Sep. 30, 2003

(30) Foreign Application Priority Data
Oct. 8, 2002 (JP) UM2002-006385

(51) Int. Cl. H01R 12/00

(52) U.S. Cl. 439/59

(57) ABSTRACT

A card connector assembly according to the present invention comprises a substrate on which wiring traces are formed and an electrical component is mounted, a plurality of contact lands connected to the respective wiring traces and arranged along an edge of the substrate, connecting traces that interconnect the respective contact lands and the respective wiring trace, and lands on the respective connecting traces, each land having a contact area for a test pin. Since test pins are in contact with the lands, no scratches are made on the contact lands. The commercial value of the card connector can thus be maintained.

### BACKGROUND OF THE INVENTION

1. Field of the Invention

The present invention relates to card connector assemblies suitable for short-range wireless apparatuses such as personal computers.

2. Description of the Related Art

Referring to FIG. 2, a known card connector assembly will now be described. On one surface of a substrate 51 being a substantially rectangular printed circuit board, wiring traces 52 are formed and electrical components 53 such as chip capacitors and resistors are mounted to constitute a desired electrical circuit (i.e. a transmission/reception circuit).

On the other surface of the substrate 51, a plurality of contact lands 54 are arranged along an edge. The contact lands 54 and the wiring traces 52 are interconnected through connecting traces 55 having various widths. The connecting traces 55 are connected to the wiring traces 52 via through-holes (not shown).

The two surfaces of this substrate 51 are covered with two insulation housings 56 while the contact lands 54 are exposed outside the housings.

The above-described card connector can be inserted into and extracted from a short-range wireless apparatus. When the card connector is inserted, the contact lands 54 of the card connector are connected to a circuit of the short-range wireless apparatus for allowing signals to be transmitted and received.

After production and before shipment, various tests are performed on the card connector to evaluate the electrical performance thereof. During the tests, test pins (not shown) from a measuring instrument come into contact with the contact lands 54. This causes scratches on the contact lands 54, resulting in degrading or loss of commercial value of the card connector.

### SUMMARY OF THE INVENTION

Accordingly, it is an object of the present invention to provide a card connector assembly including contact lands that are not damaged during testing and having a high commercial value.

According to an aspect of the present invention, a card connector assembly comprises a substrate on which wiring traces are formed and an electrical component is mounted, a plurality of contact lands connected to the respective wiring traces and arranged along an edge of the substrate, connecting traces that interconnect the respective contact lands and the respective wiring traces, and lands on the respective connecting traces, each land having a contact area for a test pin. Since the lands, instead of the contact lands, are in contact with test pins during testing, no scratches are made on the contact lands.

Preferably, each of the above-mentioned lands corresponds to each of the plurality of contact lands. Moreover, at least some of the lands have a width greater than that of the corresponding connecting trace. This structure ensures better contact with test pins.

Preferably, the land is disposed in the vicinity of the corresponding contact land. This allows precise measurement of the card connector.

Preferably, the plurality of lands are arranged in a line. This enables a simplified arrangement of the test pins and improves productivity in the manufacturing process.

Preferably, the card connector assembly further comprises a housing that covers the substrate including the lands but does not cover the plurality of contact lands. Since the lands, which are in contact with test pins during testing, are not visible from outside, the commercial value of the card connector is maintained.

### BRIEF DESCRIPTION OF THE DRAWINGS

FIG. 1 is a plan view of the main part of a card connector assembly according to the present invention; and

FIG. 2 is a plan view of the main part of a known card connector assembly.

### DESCRIPTION OF THE PREFERRED EMBODIMENT

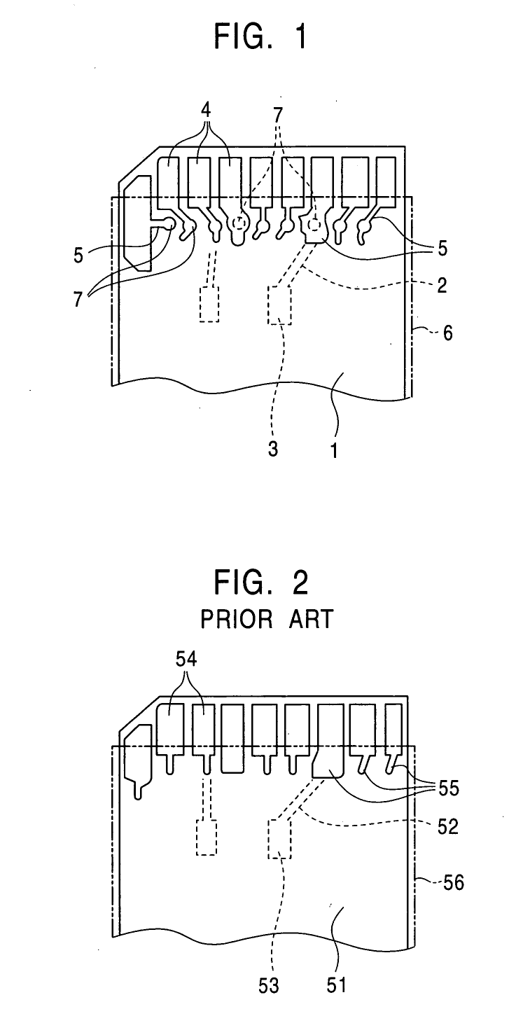

Referring to FIG. 1, a card connector assembly according to the present invention will now be described. On one surface of a substrate 1 being a substantially rectangular printed circuit board, wiring traces 2 are formed and electrical components 3 such as chip capacitors and resistors are mounted to constitute a desired electrical circuit (i.e. a transmission/reception circuit).

On the other surface of the substrate 1, a plurality of contact lands 4 are arranged along an edge. The contact lands 4 and the wiring traces 2 are interconnected through connecting traces 5 having various widths. The connecting traces 5 are connected to the wiring traces 2 via through-holes (not shown).

On each of the connecting traces 5, a land 7 having a contact area for a test pin (not shown) is provided. The lands 7 are disposed in the vicinity of the contact lands 4 and arranged in a line. In a connecting trace 5 having a large width, the land 7 may occupy a small portion thereof. In a connecting trace 5 having a small width, the width of the land 7 is greater than that of the connecting trace 5. While the lands 7 illustrated in this embodiment are of circular shape, the land 7 may be of a rectangular or any other shape.

The substrate 1, the electrical components 3, the connecting traces 5, and the lands 7, are sandwiched between two insulation housings 6, while the contact lands 4 are exposed outside the housings 6.

The above-described card connector can be inserted into and extracted from a short-range wireless apparatus. When the card connector is inserted, the contact lands 4 of the card connector are connected to a circuit of the short-range wireless apparatus for allowing signals to be transmitted and received.

In the above-described card connector, electrical performance of the card connector is tested before the card connector is covered with the housings 6. Since test pins (not shown) from a measuring instrument come into contact with the lands 7, no scratches are made on the contact lands 4. The commercial value of the card connector can thus be maintained.

What is claimed is:

1. A card connector assembly comprising:
a substrate on which wiring traces are formed and an electrical component is mounted;
a plurality of contact lands connected to the respective wiring traces and arranged along an edge of the substrate;
connecting traces that interconnect the respective contact lands and the respective wiring traces; and
lands on the respective connecting traces, each land having a contact area for a test pin.

2. A card connector assembly according to claim 1, wherein each land corresponds to each of the plurality of contact lands, and at least some of the lands have a width greater than that of the corresponding connecting trace.

3. A card connector assembly according to claim 1, wherein each land is disposed in the vicinity of the corresponding contact land.

4. A card connector assembly according to claim 1, wherein the plurality of lands are arranged in a line.

5. A card connector assembly according to claim 1, further comprising a housing that covers the substrate including the lands but does not cover the plurality of contact lands.
